(19) United States
(12) Patent Application Publication
(10) Pub. No.: US 2018/0291316 A1
(43) Pub. Date: Oct. 11, 2018

(54) WASHING METHOD

(71) Applicant: Henkel AG & Co. KGaA

(72) Inventors: Benoit Luneau, Ratingen (DE); Michael Dreja, Neuss (DE); Peter Schmiedel, Duesseldorf (DE); Christian Nitsch, Duesseldorf (DE); Arnd Kessler, Monheim am Rhein (DE); Thomas Mueller-Kirschbaum, Solingen (DE)

(73) Assignee: Henkel AG & Co. KGaA, Duesseldorf (DE)

(21) Appl. No.: 16/003,218

(22) Filed: Jun. 8, 2018

(30) Foreign Application Priority Data
Dec. 17, 2015 (DE) 102015225547.6

(51) Int. Cl. C11D 17/00; C11D 11/00

(52) U.S. Cl. CPC C11D 17/0013; C11D 11/0017; C11D 17/0039

(57) ABSTRACT

An aqueous detergent solution in a device for cleaning soiled textile substrates is disclosed. The solution contains a plurality of water-insoluble solid particles which have organic polymer material and carry polyalkoxy groups on their surface.

### FIELD OF THE INVENTION

The present invention relates to the use of particular solid particulate cleaning material in a washing method for washing textile substrates.

### BACKGROUND OF THE INVENTION

The international patent application WO 2007/128962 A1 discloses a method for cleaning soiled substrates, in particular textiles and clothing, in which method the wetted substrate is treated with particles of polymeric material in the absence of organic solvent. The polymeric particles may be coated with a surfactant that dissolves under use conditions of the particles, attaches to the substrate to be cleaned and thus improves the cleaning result overall.

According to the teaching of international patent application WO 2011/128680 A2, various components of a washing agent can be added to such combinations of polymeric particles and wetted substrate contained in a washing machine at various times, and the polymeric particles, which are themselves soiled when they are used to clean soiled substrates, can be cleaned by means of treatment using a washing agent composition; according to WO 2011/128676 A1, the various washing agent components can pass from a cartridge into the washing machine, specific amount ranges for individual washing agent ingredients being cited in the international patent application WO 2013/152065.

The international patent application WO 2012/056252 A2 discloses that the polymeric particles can be formed in a substantially cylindrical or spherical manner, their average bulk density can be in the range of from 0.5 g/cm³ to 2.5 g/cm³ and their average volume can be in the range of from 5 mm³ to 275 mm³, and said particles can be used in a weight ratio to the substrate to be cleaned of from 0.1:1 to 10:1 in washing machines having filling capacities in the range of from 5 l to 50 l.

The international patent application WO 2013/132225 A1 relates to the reintroduction of used polymeric particles into the cleaning process after the treatment thereof using washing agent dispensed from a cartridge.

The international patent application WO 2013/132223 A1 discloses that the polymeric particles may contain antimicrobial active ingredient.

According to the international patent application WO 2014/006424, the polymeric particles may comprise cleaning active ingredients in a form in which they are immobilized on the particle surface. Surfactants, enzymes, oxidizing agents and bleaching agents can be used here as cleaning active ingredients. These can be immobilized on the surface of the polymeric particles by the formation of ionic bonds, hydrogen bridge bonds or covalent bonds, it being possible for compound groups derived from compound active ingredients such as glutaraldehyde to also be located between the cleaning active ingredients and the particle surface.

In addition to the ingredients such as surfactants and builder materials that are essential to the washing process, conventional washing agents generally contain additional constituents which can be subsumed under the term “active washing auxiliaries” and comprise the very different active ingredient groups such as foam regulators, graying inhibitors, bleaching agents, bleach activators and dye transfer inhibitors. Auxiliaries of this kind also include substances of which the presence enhances the detergent power of surfactants without generally needing to have a surfactant behavior themselves. Substances of this kind are often referred to as detergent power enhancers or, in the case of a particularly significant effect with respect to oil-based or fat-based stains, as “fat boosters”.

### BRIEF SUMMARY OF THE INVENTION

The problem addressed by the present invention is that of improving the washing performance in the presence of a plurality of polymeric particles, in particular when removing spots from textile substrates having oil-containing and/or fat-containing, protein-containing and/or fruit-containing stains.

In a first embodiment, the invention relates to an aqueous washing liquor in an apparatus for cleaning soiled textile substrates, containing a plurality of water-insoluble solid particles of organic polymeric material, which particles carry polyalkoxy groups on the surface thereof.

The invention further comprises a method for removing stains from textile substrates, wherein a water-containing washing liquor, containing a plurality of water-insoluble solid particles of an organic polymeric material, which particles carry polyalkoxy groups on the surface thereof, is used.

The invention further relates to the use of a plurality of water-insoluble solid particles of organic polymeric material, which particles carry polyalkoxy groups on the surface thereof, for cleaning soiled textile substrates by bringing the particles into contact with the textile substrate in the presence of water.

The washing liquor according to the invention may be obtained manually or preferably mechanically, for example with the aid of a washing machine. In this case, it is possible if desired to use a solid or liquid washing agent before, simultaneously with or after use with the water-insoluble solid particles. In particular during the simultaneous use, the concentration of a washing agent of this kind in the liquid proportion of the washing liquor according to the invention is preferably from 1 mg/l to 500 mg/l, in particular 5 mg/l to 100 mg/l. In this case, the liquid proportion of the washing liquor is understood to mean the proportion of the entire washing liquor including the water-insoluble solid particles that is obtained when the water-insoluble solid particles are separated from the liquid proportion by centrifuging 8 kg of the washing liquor containing the solid water-insoluble particles for 5 minutes in a centrifuge having a horizontally mounted cylindrical rotary body that has an internal diameter of 515 mm and an internal depth of 370 mm at 1400 revolutions per minute.

On account of the presence of the polyalkoxy groups on the surface of the water-insoluble particles, the water affinity of the particles increases, leading to improved water absorption and, if surfactant is present, to better interaction with surfactants, and overall achieves a better cleaning performance, in particular with respect to oil-containing and/or fat-containing, protein-containing and/or fruit-containing stains. Another advantage is that the particles are less prone to microbial infection.

The water-insoluble solid particles may comprise any number of different polymers. Polyalkanes such as polyethylene and polypropylene, polyesters, polyurethanes and/or polyamides including the copolymers thereof are particularly preferred. Polyamide-containing particles and in particular particles of polyamide are preferable; particles of nylon are more preferable, most preferably in the form of nylon chips. Various nylon homopolymers or copolymers may be used, including nylon 6 and nylon 6.6. The polyamide preferably comprises nylon 6.6 homopolymer having an average molecular weight in the range of from 5,000 to 30,000 Da, preferably 10,000 to 20,000 Da, most preferably 15,000 to 16,000 Da. Water-insoluble solid particles of this kind together form, as it were, the carrier material for the polyalkoxy groups located on the surface.

It is essential to the invention that the water-insoluble particles carry polyalkoxy groups on the surface thereof. This can be achieved by reacting the above-described polymeric particles with polyalkoxy-group-carrying agents. Preferred polyalkoxy groups are composed of polymerized ethylene oxide, propylene oxide, butylene oxide and mixtures thereof. Polyalkylene glycols of this kind per se or in the form of the monofunctional derivatives thereof, for example the monoglycidyl ethers, the homodifunctional derivatives thereof, for example the diglycidyl ethers, or the heterodifunctional derivatives thereof, for example the α-glycidyl-ω-alkyl ethers, may be reacted with the water-insoluble particles. The reaction of polyamides with diglycidyl ethers is described, for example, in the Journal of Membrane Science 367 (2011), pages 273-287. The reaction of solid particles formed by ethylenically unsaturated monomers having functional acid, amide or anhydride groups with polyalkylene glycols or polyalkylene glycol monoalkyl ethers is also possible, for example. It is preferable to react the solid particles with such amounts of polyalkylene glycol or polyalkylene glycol derivates that from 1 μg/cm² to 200 μg/cm², in particular 5 μg/cm² to 50 μg/cm² polyalkoxy groups are located on the particle surface. The polyalkoxy group located on the surface may comprise terminal hydroxy groups or at least some of the polyalkoxy groups may comprise alkyl end groups, preferred alkyl end groups being methyl, ethyl, propyl and butyl groups and mixtures thereof. As explained above, the polyalkoxy groups are chemically bonded to the particle surface via glycidyl units or via ester bonds, for example. In this case, the molecular weight of a polyalkoxy group, in particular a polyethoxy group, is preferably in the range of from 200 g/mol to 100,000 g/mol, in particular from 1,000 g/mol to 30,000 g/mol.

The water-insoluble solid particles or shaped bodies used according to the invention are preferably of such a shape and size that allows good flowability and close contact with the material to be cleaned. Preferred shapes of the particles include spheres and cubes, but the preferred particle shape is cylindrical. The particles are preferably dimensioned such that they each have a weight in the range of from 20 mg to 50 mg, preferably 30 mg to 40 mg, or such that at least the number average weight of the particles is in these ranges. In the case of the most preferred cylindrically shaped particles, the preferred particle diameter is from 1.5 mm to 6.0 mm, particularly preferably 2.0 mm to 5.0 mm, most preferably 2.5 mm to 4.5 mm, while the length of the cylindrical particles is preferably in the range of from 2.0 mm to 6.0 mm, particularly preferably 3.0 mm to 5.0 mm and most preferably in the region of 4.0 mm.

### DETAILED DESCRIPTION OF THE INVENTION

Preferably before the treatment according to the invention with the water-insoluble particles, the material to be cleaned is moistened by wetting with water in order to provide an additional improvement for the washing liquor and thus allow an improvement in the transport properties of the laundry and the particles within the system, meaning that removing dirt and spots is made easier. It is most convenient for the wetting to take place by means of contact with tap water. The wetting treatment is preferably carried out such that a weight ratio of laundry to water is achieved in the range of from 1:0.1 to 1:5; the weight ratio is more preferably in the range of from 1:0.2 to 1:2, particularly favorable results being achieved using ratios such as 1:0.2, 1:1 and 1:2. However, in some cases, successful results can be achieved using a weight ratio of up to 1:50, although ratios of this kind are not preferred in view of the significant amounts of waste water produced.

In the use according to the invention and the method according to this aspect of the invention, which can be considered to be an interstitial method between the cleaning and scouring stages, a weight ratio of laundry to water-insoluble solid particles is preferably set in the range of from 1:1 to 1:30, in particular 1:1.5 to 1:2.5, most particularly of 1:2. In this case, the proportion of the water-insoluble solid particles is determined as the weight of the particles in the dry state, i.e. after being stored for 24 hours at 21 ° C. and a relative humidity of 65%.

After their use in the method according to the invention or for the use according to the invention, the particles still exhibit the surface modification essential to the invention; said particles can be reused in a satisfactory manner, although a certain deterioration in the performance can generally be observed after three or more uses of the particles. The water-insoluble solid particles can regenerate in a manner that is known per se, as is described in WO 2012/035342 A1, for example. In the context of the present invention, the regeneration is carried out by bringing the particles into contact for example in a separate rinse cycle, optionally by adding cleaning agents which may also be aggressive in nature. The temperature of the regeneration step is thus at least independent of the washing temperature when the laundry is removed before the regeneration of the particles.

Another embodiment of the invention is an apparatus for cleaning soiled textile substrates comprising a plurality of water-insoluble solid particles of organic polymeric material, which particles carry polyalkoxy groups on the surface thereof, and a reservoir for holding the particles inside or outside the apparatus.

The apparatus according to the invention typically comprises a flap door in a housing in order to allow access to the interior of the washing drum, in order to provide a substantially closed system. The door preferably closes an access to a cylindrical drum which is rotatably mounted in an additional stationary drum, while the rotatably mounted cylinder drum is vertically attached within the housing. As a result, a front-loading device is preferred. Alternatively, the cylindrical drum can be attached vertically within the housing and the access device can be located in the upper face of the apparatus, the rotatable drum likewise needing to be equipped with an access apparatus.

The apparatus according to the invention is suitable for providing contact of the particles with the soiled substrate. Ideally, the particles should be circulated efficiently in order to facilitate effective cleaning.

According to the invention, the apparatus comprises at least one reservoir, in particular having a corresponding controller, for the water-insoluble solid particles, which reservoir is located, for example, inside the washing machine, contains the particles for regeneration and is suitable for controlling the flow of particles inside the washing machine.

What is claimed is:

1. An aqueous washing liquor for cleaning soiled textile substrates, comprising a plurality of water-insoluble solid particles of organic polymeric material, wherein the particles carry polyalkoxy groups on the surface thereof.

2. The aqueous washing liquor according to claim 1, wherein the weight ratio of textile substrates to water-insoluble solid particles is in the range of from 1:1 to 1:30.

3. The aqueous washing liquor according to claim 2, wherein the weight ratio of textile substrates to water-insoluble solid particles is in the range of from 1:1.5 to 1:2.5.

4. The aqueous washing liquor according to claim 1, wherein the water-insoluble solid particles contain polyalkanes, polyesters, polyurethanes, polyamides, or copolymers thereof.

5. The aqueous washing liquor according to claim 1, wherein the water-insoluble solid particles are present in the form of spheres, cubes, cylinders, or mixtures thereof.

6. The aqueous washing liquor according to claim 1, wherein the water-insoluble solid particles each have a weight in the range of from 20 mg to 50 mg.

7. The aqueous washing liquor according to claim 1, wherein the polyalkoxy groups are composed of polymerized ethylene oxide, propylene oxide, butylene oxide, or mixtures thereof and comprise terminal hydroxy groups, or at least some of the polyalkoxy groups comprise alkyl end groups.

8. The aqueous washing liquor according to claim 1, wherein there are from 1 μg/cm² to 200 μg/cm² polyalkoxy groups on the particle surface.

9. The aqueous washing liquor according to claim 8, wherein there are from 5 μg/cm² to 50 μg/cm² polyalkoxy groups on the particle surface.

10. An apparatus for cleaning soiled textile substrates comprising a plurality of water-insoluble solid particles of organic polymeric material, wherein the particles carry polyalkoxy groups on the surface thereof, and a reservoir for holding the particles inside or outside the apparatus.

11. The apparatus according to claim 10, wherein the water-insoluble solid particles contain polyalkanes, polyesters, polyurethanes, polyamides, or copolymers thereof.

12. The apparatus according to claim 10, wherein the water-insoluble solid particles are present in the form of spheres, cubes, cylinders, or mixtures thereof.

13. The apparatus according to claim 10, wherein the water-insoluble solid particles each have a weight in the range of from 20 mg to 50 mg.

14. The apparatus according to claim 10, wherein the polyalkoxy groups are composed of polymerized ethylene oxide, propylene oxide, butylene oxide, or mixtures thereof and comprise terminal hydroxy groups, or at least some of the polyalkoxy groups comprise alkyl end groups.

15. The apparatus according to claim 10, wherein there are from 1 μg/cm² to 200 μg/cm² polyalkoxy groups on the particle surface.

16. A method for removing stains from textile substrates, comprising a step of bringing a plurality of water-insoluble solid particles of organic polymeric material into contact with the textile substrates in the presence of water; wherein the particles carry polyalkoxy groups on the surface thereof.

17. The method according to claim 16, wherein the weight ratio of textile substrates to water-insoluble solid particles is in the range of from 1:1 to 1:30.

18. The method according to claim 17, wherein the weight ratio of textile substrates to water-insoluble solid particles is in the range of from 1:1.5 to 1:2.5.

19. The method according to claim 16, wherein the water-insoluble solid particles contain polyalkanes, polyesters, polyurethanes, polyamides, or copolymers thereof.

20. The method according to claim 16, wherein the water-insoluble solid particles each have a weight in the range of from 20 mg to 50 mg.
